(19) United States
(12) Patent Application Publication
(10) Pub. No.: US 2013/0293712 A1
(43) Pub. Date: Nov. 7, 2013

(54) BACK-UP CAMERA CAPABILITY THROUGH A VEHICLE-INTEGRATED WIRELESS COMMUNICATION DEVICE

(71) Applicants: Phillip M. Turner, Montrose, MI (US); Russell J. Peyerk, Romeo, MI (US)

(72) Inventors: Phillip M. Turner, Montrose, MI (US); Russell J. Peyerk, Romeo, MI (US)

(73) Assignee: GM GLOBAL TECHNOLOGY OPERATIONS LLC, Detroit, MI (US)

(21) Appl. No.: 13/465,147

(22) Filed: May 7, 2012

(51) Int. Cl. H04N 7/18; H04B 7/00

(52) U.S. Cl. 348/148; 348/E07.085

(57) ABSTRACT

Back-up camera capabilities through a vehicle-integrated wireless communication device include receiving a triggering event via a control system of a vehicle and activating a back-up function responsive to the triggering event. The back-up function includes sending a request to a wireless communication device to transmit in real-time a recording from a recording component of the wireless communication device to a wireless interface of the control system. The back-up camera capabilities also including receiving the recording from the wireless communication device as a live data stream, transmitting the recording to a display device of the vehicle, and displaying the recording on the display device.

### FIELD OF THE INVENTION

The subject invention relates to vehicle applications and, more particularly, to back-up camera capability implemented through a vehicle-integrated wireless communication device.

### BACKGROUND

Back-up camera systems in automobiles provide drivers with a rear view of a back-up operation when a vehicle is put in reverse gear in order for drivers to view and avoid any potential obstacles, as well as safely guide the drivers through a pathway, such as a drive-way, parking lot, etc. A back-up camera system is typically not provided as a standard feature on vehicles, but may be added on by the manufacturer as an option for a fee.

Unfortunately, many budget conscious consumers may not be able to afford this add on despite its usefulness. In addition, even those vehicles that are equipped with built-in back-up camera systems can experience difficulties in detecting obstructions under conditions such as when towing another vehicle or trailer.

Accordingly, it is desirable to provide back-up camera capabilities to vehicles through a wireless communication device.

### SUMMARY OF THE INVENTION

In one exemplary embodiment of the invention, a method for implementing vehicle back-up capabilities is provided. The method includes receiving a triggering event via a control system of a vehicle and activating a back-up function responsive to the triggering event. The back-up function includes sending a request to a wireless communication device to transmit in real-time a recording from a recording component of the wireless communication device to a wireless interface of the control system. The back-up camera capabilities also including receiving the recording from the wireless communication device as a live data stream, transmitting the recording to a display device of the vehicle, and displaying the recording on the display device.

In another exemplary embodiment of the invention a system for implementing vehicle back-up capabilities is provided. The system includes a computer processor and logic executable by the computer processor. The logic implements a method. The method includes receiving a triggering event via a control system of a vehicle and activating a back-up function responsive to the triggering event. The back-up function includes sending a request to a wireless communication device to transmit in real-time a recording from a recording component of the wireless communication device to a wireless interface of the control system. The back-up camera capabilities also including receiving the recording from the wireless communication device as a live data stream, transmitting the recording to a display device of the vehicle, and displaying the recording on the display device.

In yet another exemplary embodiment of the invention, a computer program product for implementing vehicle back-up capabilities is provided. The computer program product comprises a computer-readable storage medium having instructions embodied thereon, which when executed by the computer processor causes the computer processor to implement a method. The method includes receiving a triggering event via a control system of a vehicle and activating a back-up function responsive to the triggering event. The back-up function includes sending a request to a wireless communication device to transmit in real-time a recording from a recording component of the wireless communication device to a wireless interface of the control system. The back-up camera capabilities also including receiving the recording from the wireless communication device as a live data stream, transmitting the recording to a display device of the vehicle, and displaying the recording on the display device.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a system upon which vehicle back-up capabilities may be implemented in accordance with an exemplary embodiment;

FIG. 2 is a flow diagram describing a process for implementing vehicle back-up capabilities in accordance with an exemplary embodiment;

FIG. 3 is a display device and panel for implementing vehicle back-up capabilities in accordance with an exemplary embodiment;

FIG. 4 is a system upon which vehicle back-up capabilities may be implemented in accordance with an alternative exemplary embodiment;

FIG. 5 is a flow diagram describing a process for implementing vehicle back-up capabilities via the system of FIG. 4 in accordance with an exemplary embodiment; and

FIG. 6 is a display device and panel for implementing vehicle back-up capabilities via the system of FIG. 4 in accordance with an exemplary embodiment.

### DESCRIPTION OF THE EMBODIMENTS

The following description is merely exemplary in nature and is not intended to limit the present disclosure, its application or uses.

In accordance with an exemplary embodiment of the invention, vehicle back-up capabilities through a vehicle-integrated wireless communication device are provided. The exemplary vehicle back-up capabilities enable telematics-equipped vehicles having no existing back-up components with the ability to perform back-up operations utilizing features of a wireless communication device. In another exemplary embodiment, the vehicle back-up capabilities provide auxiliary back-up capabilities to vehicles installed with existing (i.e., primary) back-up components. The auxiliary back-up capabilities are invoked when the existing back-up components are impaired or when the existing back-up components do not provide a clear view during a back-up operation.

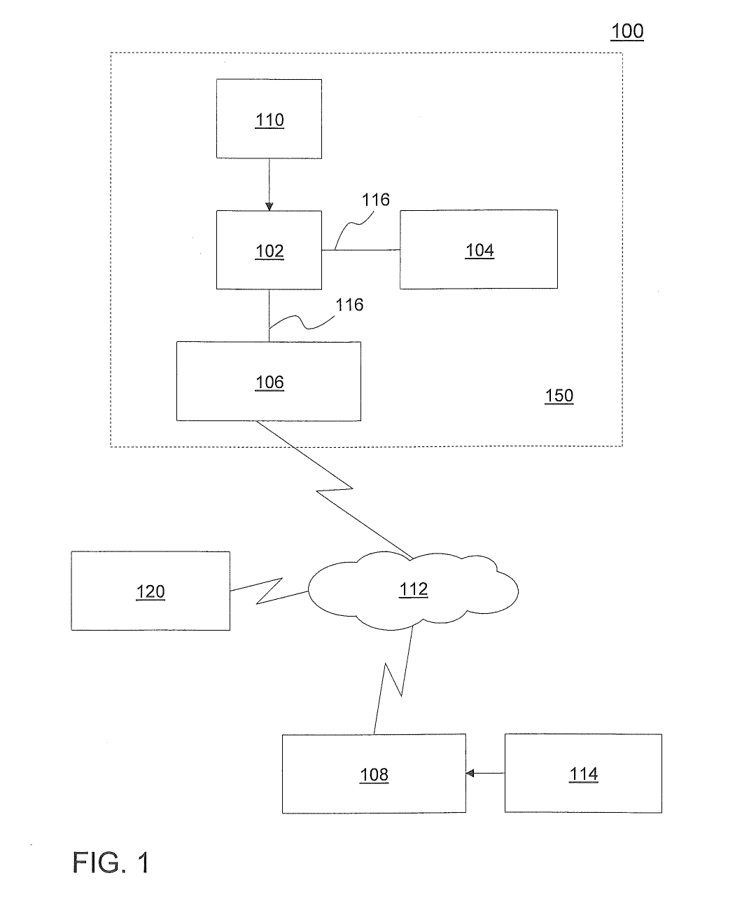

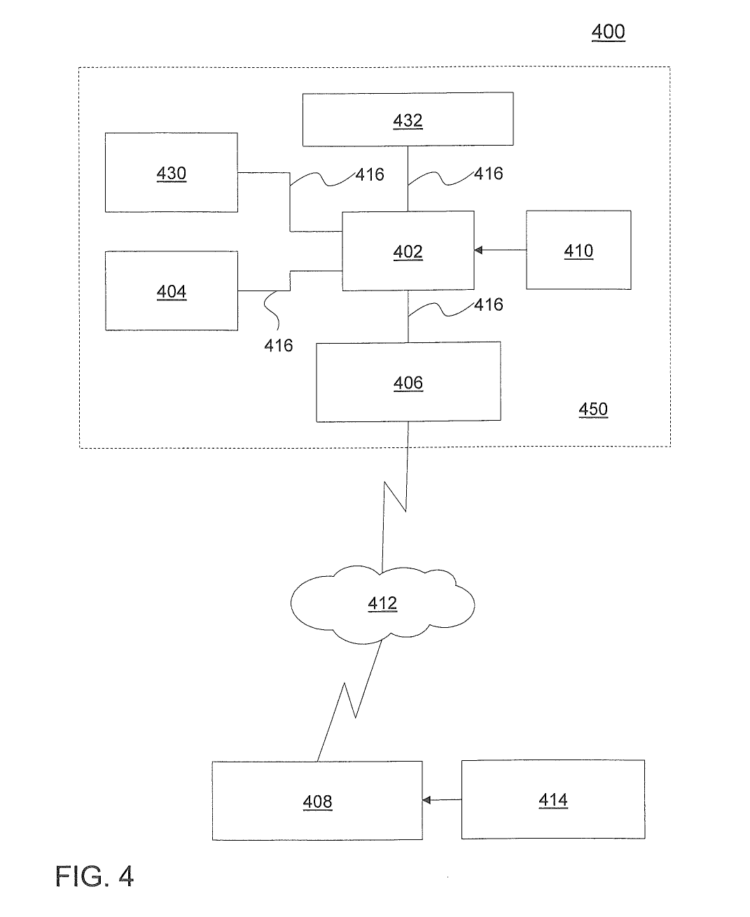

A telematics-equipped system is shown in FIGS. 1-3, and an auxiliary back-up system is shown in FIGS. 4-6.

Turning now to FIGS. 1-3, a system 100 upon which the vehicle back-up capabilities may be implemented in accordance with an exemplary embodiment will now be described. The system 100 includes a wireless communication device 108, components of a vehicle 150, a telematics server 120, and a network 112.

The wireless communication device 108 represents a mobile device, such as a smart phone. The wireless communication device 108 includes a recording component 114 built in to the device 108. The recording component 114 may be a video camera. The wireless communication device 108 is configured to communicate using cellular communication technologies over the network 112, which includes a cellular network. In an embodiment, the network 112 may also be configured for enabling satellite transmissions, e.g., in cases where vehicles include global positioning system components.

The vehicle 150 includes a vehicle control system 102, a display device 104, and a wireless interface 106 communicatively coupled to one another over a network 116. The network 116 may be implemented through physical wiring or may be a wireless network. In one embodiment, the network 116 is a wireless local area network (WLAN).

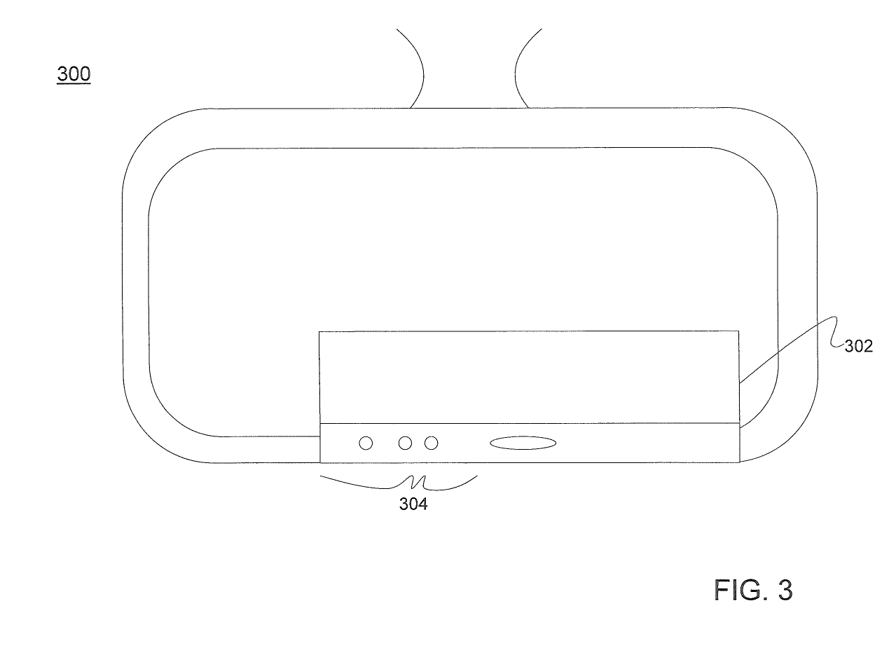

The vehicle control system 102 (also referred to herein as “control system”) includes one or more computer processors that are configured to execute logic 110 for implementing the exemplary vehicle back-up capabilities described herein. The control system 102 may be implemented in hardware, software, or a combination thereof. The logic 110 may reside in memory of the control system 102. The logic 110 is configured to provide a user interface, which may be presented to a user in-vehicle via a display panel of the display device 104. A sample user interface screen of the user interface is shown in FIG. 3.

The display device 104 may be implemented as a panel within a rear-view mirror of the vehicle 150, or may be implemented by a display screen built in to a vehicle console (e.g., as part of a navigation or infotainment system).

The wireless interface 106 may be implemented using telematics components typically found in a vehicle that subscribes to telematics services (e.g., roadside assistance and related services offered via OnStar®). The wireless interface 106 may include a wireless transceiver and communications components capable of enabling data and voice transmissions to and from the vehicle 150. In an embodiment, these telematics services are provided by the telematics server 120 over the network 112. The telematics server 120 may be implemented in part by a mainframe computer or other high-speed computer processing device.

In operation, a user disposes the wireless communication device 108 in a location and orients the recording component 114 to correspond with a desired viewpoint. For example, the wireless communication device 108 may be affixed to a rear portion of the vehicle 150 with the recording component facing outward, the wireless communication device 108 may be handheld by a user who is not the operator of the vehicle 150, or the wireless communication device 108 may be placed on an item or fixture that is in proximity of the vehicle 150. The recording component 114 may be activated at this time. The logic 110 is configured to monitor activities through the vehicle control system 102 to identify a triggering event that will cause the vehicle back-up functions to become activated.

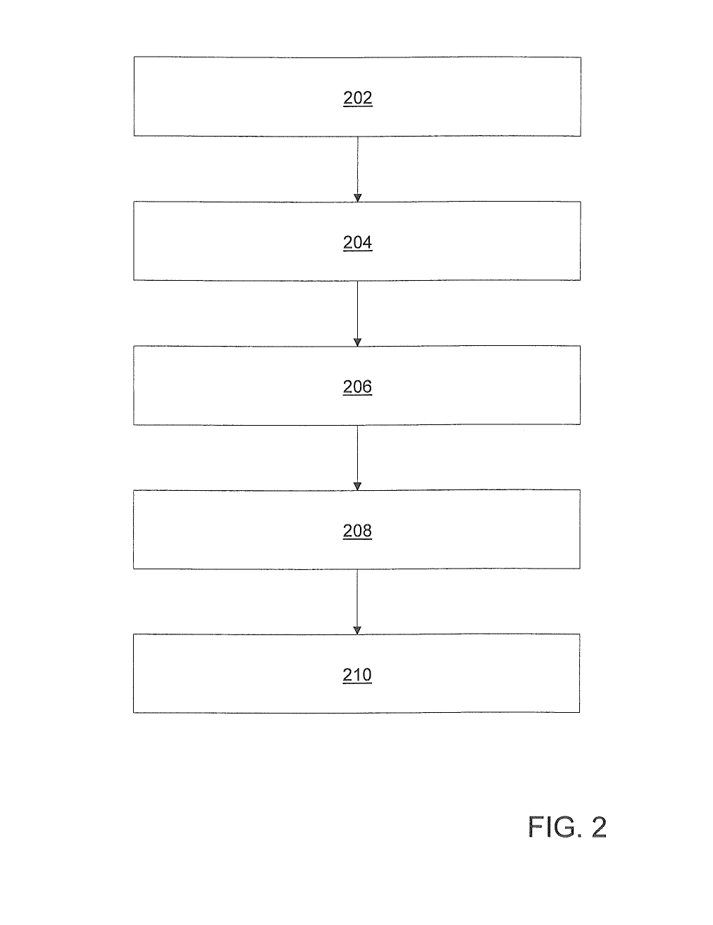

Turning now to FIG. 2, a flow diagram describing a process for implementing vehicle back-up capabilities in accordance with an exemplary embodiment will now be described.

At step 202, the vehicle control system 102 identifies a trigger event for activating a back-up function on the vehicle 150 via the logic 110. The triggering event may be configured in a variety of ways. For example, the triggering event may be implemented as a selectable option on the display device 104 via the logic 110 and vehicle control system 102. By selecting an input option on the display device 104, the logic 110 can instruct the user on activating and deactivating the vehicle back-up capabilities. As shown in FIG. 3, the display device is implemented as a rear-view mirror 300, which includes a display panel 302 that is embedded in the rear-view mirror 300. Input buttons 304 on the rear-view mirror 300 may be used to implement selections by the user, and the display panel 302 displays prompts or instructions provided by the logic 110, in addition to the back-up video recording received from the wireless communication device 108. As indicated above, it will be understood that the display device 104 may be implemented using other vehicle components, such as a navigation screen. Alternatively, the triggering event may be activated by the logic 110 when the vehicle controls system 102 detects that the vehicle is engaged in reverse gear.

At step 204, the logic 110 identifies a wireless communication device 108 via the network 112 and wireless interface 106. The identification may be implemented by a function on the wireless interface 106. For example a user may activate the telematics component (wireless interface 106) of the vehicle 150, which sends a signal to the telematics server 120. The telematics server 120 in turn identifies the location of the vehicle 150 using GPS coordinates of the vehicle's location. The user may be prompted by the logic 110 to enter a phone number of the wireless communication device 108 and the telematics server 120 identifies the wireless communication device 108 by the phone number and its GPS coordinates. The phone number enables the telematics server 120 to distinguish the wireless communication device 108 from other devices that may be in proximity of the vehicle 150.

At step 206, the logic 110 generates and sends a request to the wireless communication device 108 to transmit video recorded by the recording component 114 to the vehicle 150. The request may be sent to the wireless communication device 108 over the network 112. The wireless communication device 108 transmits the recording as a live data stream to the telematics server 120, which server 120 forwards the recording to the wireless interface 106 over the network 112. The transmissions may include compressing the data stream for faster communication.

At step 208, the logic 110 receives the recorded video via the wireless interface 106 and renders the recorded video to the display device 104 at step 210. The rendering may include flipping the images horizontally so that the resulting video is a mirror image of the original video stream. In this manner, the orientation of the view is consistent with the view as seen from the driver's viewpoint.

In an alternative exemplary embodiment, the vehicle back-up capabilities may be implemented for vehicles having existing back-up systems (also referred to herein as “primary back-up systems). In this embodiment, the vehicle back-up capabilities are performed as an auxiliary back-up system.

Turning now to FIGS. 4-6, an alternative exemplary vehicle back-up system 400 will now be described. The system 400 includes a wireless communication device 408, components of a vehicle 450, and a network 412.

The wireless communication device 408 represents a mobile device, such as a smart phone. The wireless communication device 408 includes a recording component 414 built in to the device 408. The recording component 414 may be a video camera. The wireless communication device 408 is configured to communicate using short-range communication technologies (e.g., Bluetooth®) over the network 412.

The vehicle 450 includes a vehicle control system 402, a display device 404, and a wireless interface 406 communicatively coupled to one another over a network 416. The network 416 may be implemented through physical wiring or may be a wireless network. In one embodiment, the network 416 is a wireless local area network (WLAN).

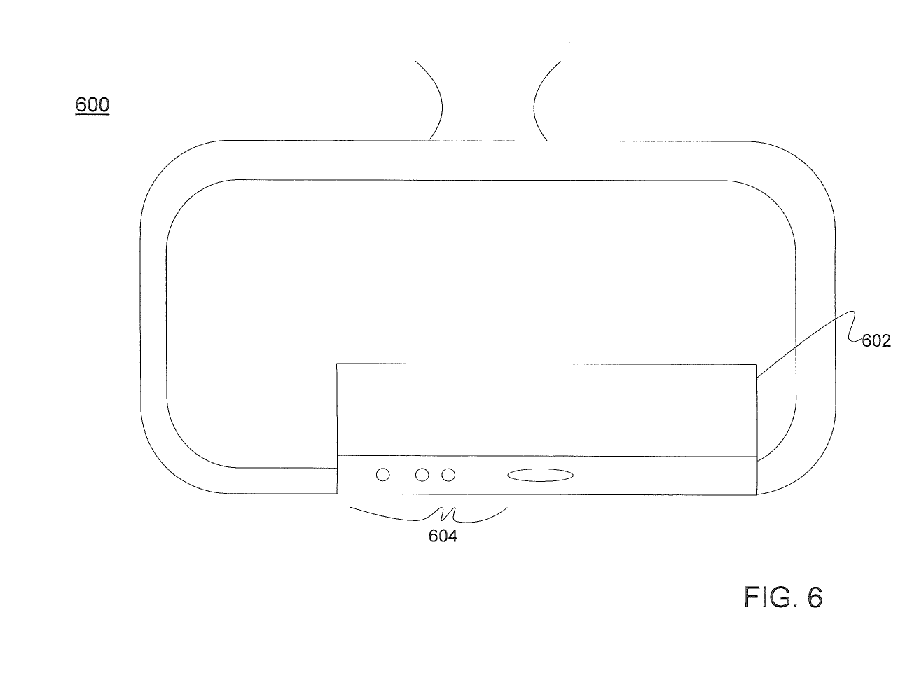

The vehicle control system 402 (also referred to herein as “control system”) includes one or more computer processors that are configured to execute logic 410 for implementing the exemplary auxiliary vehicle back-up capabilities described herein. The control system 402 may be implemented in hardware, software, or a combination thereof. The logic 410 may reside in memory of the control system 402. The logic 410 is configured to provide a user interface, which may be presented to a user in-vehicle via a display panel of the display device 404. A sample user interface screen of the user interface is shown in FIG. 6.

The display device 404 may be implemented as a panel within a rear-view mirror of the vehicle 450, or may be implemented by a display screen built in to a vehicle console (e.g., as part of a navigation or infotainment system).

The wireless interface 406 may be implemented using short-range communication-enabled components, such as Bluetooth®—or Wi-Fi-enabled devices. For example, the wireless interface 406 may include a wireless transceiver and communications components capable of enabling transmissions to and from the vehicle 450.

The vehicle 450 also includes back-up system components as part of a vehicle back-up system (also referred to herein as a “primary back-up system”). The back-up components include a back-up sensor 432 and a recording component 430. The back-up sensor 432 may be a motion sensor, and the recording component 430 may be a video camera.

In operation, a user activates the auxiliary back-up system either simultaneously with the primary back-up system or in lieu of the primary back-up system as configured via the logic 410. In cases where a desired viewpoint is blocked (e.g., a trailer being towed by the vehicle 150 blocks the view of the primary back-up system's recording device 430), the auxiliary back-up system can be invoked.

A user disposes the wireless communication device 408 in a location and orients the recording component 414 to correspond with a desired viewpoint. For example, the wireless communication device 408 may be affixed to a rear portion of a trailer in tow by the vehicle 450 with the recording component facing outward, the wireless communication device 408 may be handheld by a user who is not the operator of the vehicle 450, or the wireless communication device 408 may be placed on an item or fixture that is in proximity of the vehicle 450. The recording component 414 may be activated at this time. The logic 410 is configured to monitor activities through the vehicle control system 402 to identify a triggering event that will cause the vehicle back-up functions to become activated.

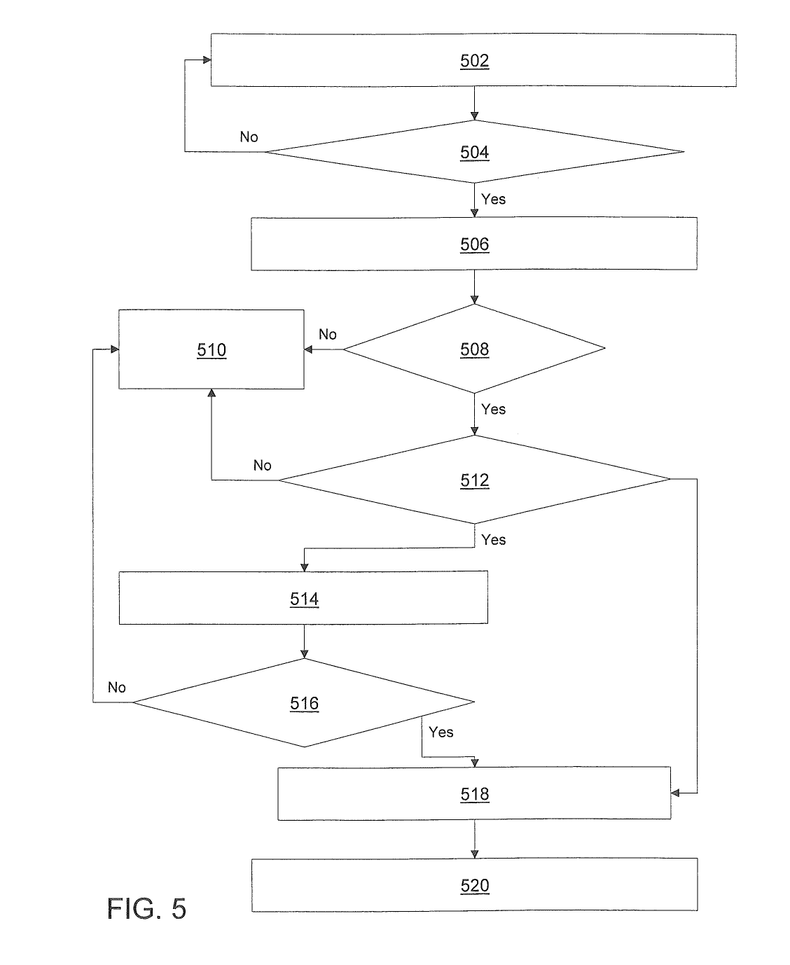

Turning now to FIG. 5, a flow diagram describing a process for implementing vehicle back-up capabilities in accordance with an exemplary embodiment will now be described.

At step 502, the wireless interface 406 monitors for the presence of the wireless communication device 408 over a short-range communication network, such as network 412. If the presence is detected, the wireless communication device 408 and the wireless interface 406 exchange private keys in order to facilitate communications between the two.

At step 504, the logic 410 determines whether a trigger event has occurred (e.g., the vehicle 450 is engaged in reverse gear and/or the back-up sensor 432 detects an obstacle). Alternatively, the triggering event may be implemented as a user-initiated activity, such as selection of an option via the user interface provided by the logic 410. If a triggering event has not occurred, the process returns to step 502, and the wireless interface 406 continues to monitor for the presence of the wireless communication device 408.

At step 504, if the trigger event has occurred, the primary back-up system is activated via the recording component 430 at step 506. The view (i.e., video stream) from the recording component 430 is transmitted over the network 416 and presented on the display device 404.

At step 508, the logic 410 determines whether a block condition has occurred (e.g., a blocked view such as a trailer in two by the vehicle 150). If not, the primary back-up system continues to record video and the video is transmitted and presented on the display device 404 at step 510.

If, however, the logic 410 determines that a block condition has occurred, the logic 410 determines whether the wireless communication device 508 is present at step 512. If not, this means that no wireless communication device is able to act as an auxiliary backup system, and the process proceeds to step 510, whereby the primary back-up system continues to record video and the video is presented on the display device 404 or the primary back-up system may be configured to discontinue recording.

If the logic 410 determines that the wireless communication device 408 is present, the logic 410 prompts the user to select a new view at step 514. For example, the new view may be implemented as a selectable option on the display device 404 via the logic 410 and vehicle control system 402. By selecting an input option on the display device 404, the logic 410 can instruct the user on activating and deactivating the auxiliary vehicle back-up capabilities. As shown in FIG. 6, the display device is implemented as a rear-view mirror 600, which includes a display panel 602 that is embedded in the rear-view mirror 600. Input buttons 604 on the rear-view mirror 600 may be used to implement selections by the user, and the display panel 602 displays prompts or instructions provided by the logic 410, in addition to the back-up video recording received from the wireless communication device 408. As indicated above, it will be understood that the display device 404 may be implemented using other vehicle components, such as a navigation screen. Alternatively, the triggering event may be activated by the logic 410 when the vehicle controls system 402 detects that the vehicle is engaged in reverse gear.

If the user does not select the new view at step 516, the process proceeds to step 510, whereby the primary back-up system continues to record video and the video is presented on the display device 404 at step 510.

If, however, the user selects the new view at step 516, the logic 410 generates and sends a request via the wireless interface 406 to the wireless communication device 408 over the network 412 to transmit video at step 518. Once the video is received from the wireless communication device 408, it is rendered on the display device 404 as auxiliary back-up video at step 520. The rendering may include flipping the images horizontally so that the resulting video is a mirror image of the original video stream. In this manner, the orientation of the view is consistent with the view as seen from the driver's viewpoint.

In an embodiment, the primary back-up system's video stream may be displayed on the display device 602 simultaneously with the auxiliary back-up system's video stream in a split screen fashion. Alternatively, the logic 610 may be configured to enable the user to select from the two video streams.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the application.

What is claimed is:

1. A method, comprising:
receiving a triggering event via a control system of a vehicle;
activating a back-up function responsive to the triggering event, the back-up function including sending a request to a wireless communication device to transmit in real-time a recording from a recording component of the wireless communication device to a wireless interface of the control system;
receiving the recording from the wireless communication device as a live data stream, and transmitting the recording to a display device of the vehicle; and
displaying the recording on the display device.

2. The method of claim 1, wherein the wireless interface forms part of a telematics component disposed in the vehicle, the telematics component communicatively coupled to the control system, the telematics component transmitting the request via a telematics server over a network.

3. The method of claim 2, wherein the wireless communication device in communicative range of the vehicle is disposed at a location such that a recording component on the wireless communication device is oriented in a direction that is outward from a rear portion of the vehicle.

4. The method of claim 3, wherein the wireless interface includes a short-range wireless communication network-enabled transceiver, the method further comprising:
initiating a pairing function, via the control system of the vehicle, between the wireless communication device and the wireless interface in response to determining, via the control system, that the wireless communication device is in communicative range of the vehicle;
wherein the activating the back-up function is performed using information derived from the pairing function; and
wherein the wireless interface and the wireless communications device communicate over a short-range wireless communication network.

5. The method of claim 3, wherein the triggering event includes determining, via sensor data from a primary back-up system in the vehicle, that a view from a camera component of the primary back-up system is blocked.

6. The method of claim 3, further comprising ascertaining whether the wireless communication device is in communicative range of the vehicle responsive to determining the vehicle is engaged in reverse gear.

7. The method of claim 3, wherein the displaying the recording on the display device includes displaying the recording on a first portion of a split screen of the display device, the method further comprising:
receiving, via the control system and the existing back up system, another recording from a camera component of the existing back up system; and
displaying the other recording in a second portion of the split screen of the display device;
wherein the first recording and the other recording are simultaneously displayed on the display device.

8. The method of claim 1, wherein the triggering event includes:
prompting a user through a user interface presented on the display device to activate the back-up function; and
receiving an affirmation from the user responsive to the prompting.

9. A system, comprising:
a computer processor integrated within a vehicle; and
logic executable by the computer processor, the logic implementing a method, comprising:
receiving a triggering event via the computer processor;
activating a back-up function responsive to the triggering event, the back-up function including sending a request to a wireless communication device to transmit in real-time a recording from a recording component of the wireless communication device to a wireless interface of the vehicle;
receiving the recording from the wireless communication device as a live data stream, and transmitting the recording to a display device of the vehicle; and
displaying the recording on the display device.

10. The system of claim 9, wherein the wireless interface forms part of a telematics component disposed in the vehicle, the telematics component communicatively coupled to the computer processor, the telematics component transmitting the request via a telematics server over a network.

11. The system of claim 10, wherein the wireless communication device in communicative range of the vehicle is disposed at a location such that a recording component on the wireless communication device is oriented in a direction that is outward from a rear portion of the vehicle.

12. The system of claim 11, wherein the wireless interface includes a short-range wireless communication network-enabled transceiver, the method further comprising:
initiating a pairing function, via the wireless interface of the vehicle, between the wireless communication device and the wireless interface in response to determining that the wireless communication device is in communicative range of the vehicle;
wherein the activating the back-up function is performed using information derived from the pairing function; and
wherein the wireless interface and the wireless communications device communicate over a short-range wireless communication network.

13. The system of claim 11, wherein the triggering event includes determining, via sensor data from a primary back-up system in the vehicle, that a view from a camera component of the primary back-up system is blocked.

14. The system of claim 11, further comprising ascertaining whether the wireless communication device is in communicative range of the vehicle responsive to determining the vehicle is engaged in reverse gear.

15. The system of claim 11, wherein the displaying the recording on the display device includes displaying the recording on a first portion of a split screen of the display device, the method further comprising:
receiving, via the computer processor and the existing back up system, another recording from a camera component of the existing back up system;
displaying the other recording in a second portion of the split screen of the display device; and
wherein the first recording and the other recording are simultaneously displayed on the display device.

16. The system of claim 9, wherein the triggering event includes:
prompting a user through a user interface presented on the display device to activate the back-up function; and
receiving an affirmation from the user responsive to the prompting.

17. A computer program product comprising a computer-readable storage medium having instructions embodied thereon, which when executed by a computer cause a computer to implement a method, the method comprising:
receiving a triggering event via a control system of a vehicle;
activating a back-up function responsive to the triggering event, the back-up function including sending a request to a wireless communication device to transmit in real-time a recording from a recording component of the wireless communication device to a wireless interface of the control system;
receiving the recording from the wireless communication device as a live data stream, and transmitting the recording to a display device of the vehicle; and
displaying the recording on the display device.

18. The computer program product of claim 17, wherein the wireless interface forms part of a telematics component disposed in the vehicle, the telematics component communicatively coupled to the control system, the telematics component transmitting the request via a telematics server over a network.

19. The computer program product of claim 18, wherein the wireless communication device in communicative range of the vehicle is disposed at a location such that a recording component on the wireless communication device is oriented in a direction that is outward from a rear portion of the vehicle.

20. The computer program product of claim 19, wherein the wireless interface includes a short-range wireless communication network-enabled transceiver, the method further comprising:
initiating a pairing function, via the control system of the vehicle, between the wireless communication device and the wireless interface in response to determining, via the control system, that the wireless communication device is in communicative range of the vehicle;
wherein the activating the back-up function is performed using information derived from the pairing function; and
wherein the wireless interface and the wireless communications device communicate over a short-range wireless communication network.
